(19) United States
(12) Patent Application Publication
(10) Pub. No.: US 2012/0120030 A1
(43) Pub. Date: May 17, 2012

(54) Display with an Optical Sensor

(75) Inventors: John P. McCarthy, Pleasanton, CA (US); John J. Briden, San Francisco, CA (US)

(73) Assignee: HEWLETT-PACKARD DEVELOPMENT COMPANY, L.P., Houston, TX (US)

(21) Appl. No.: 13/386,437

(22) PCT Filed: Jul. 23, 2009
(86) PCT No.: PCT/US2009/051587

§ 371 Date: Jan. 23, 2012

(51) Int. Cl. G06F 3/042

(52) U.S. Cl. 345/175

(57) ABSTRACT

A three dimensional optical sensor 115 can generate three dimensional data for an object 120 contacting a display system. If the object contacts the display system a controller can activate a function of a computing device only if the object extends from the display system to a distance greater than a programmed distance 130.

### BACKGROUND

A resistive touch screen panel is composed of two thin, metallic, electrically conductive layers separated by a narrow gap. When an object, such as a finger, presses down on a point on the panel's outer surface the two metallic layers become connected at that point and the panel then behaves as a pair of voltage dividers with connected outputs. This causes a change in the electrical current which is registered as a touch event and sent to the controller for processing. A capacitive touch screen panel is a sensor that is a capacitor in which plates include overlapping areas between the horizontal and vertical axes in a grid pattern. The human body also conducts electricity and a touch on the surface of the sensor will affect the electric field and create a measurable change in the capacitance of the device.

### BRIEF DESCRIPTION OF THE DRAWINGS

Some embodiments of the invention are described with respect to the following figures:

FIG. 1a is a display according to an exemplary embodiment of the invention;

FIG. 1b is a display according to an exemplary embodiment of the invention;

FIG. 2 is a portion of the display according to an exemplary embodiment of the invention;

FIG. 3 is a three dimensional optical sensor according to an exemplary embodiment of the invention;

FIG. 4 is a display according to an exemplary embodiment of the invention;

FIG. 5 is a display according to an exemplary embodiment of the invention;

FIG. 6 is a block diagram according to an exemplary embodiment of the invention; and

FIG. 7 is a flow diagram according to an exemplary embodiment of the method of the invention.

### DETAILED DESCRIPTION

A touch screen can be used to activate items on a display. If an object contacts the display a signal can be sent to a computing device for presenting the location of the contact on the display. The location on the display may cause an item displayed on the display to be activated. For example, if the item is an icon for a program touching the display at the location of the icon may launch the program.

If the object unintentionally contacts the display unintentional operations may be generated by a computing device. For example an unintentional operation may be unintentionally launching an application, canceling a lengthy process or waking a computing device from a sleep state.

A display can include a three dimensional optical sensor to determine the depth an object that is captured by the optical sensor is from the optical sensor. If the contact by an object is a contaminant on the display then the size of the object or the distance the object extends from the display can be used to disregard the contact. The contaminant can be for example dust, dirt or insects. If the object is an insect and while contacting the display the insect does not extend to a programmed distance in front of the display the computing device can disregard the contact.

The resistive touch screen panel includes a glass panel that is covered with a conductive and a resistive metallic layer. These two layers are held apart by spacers, and a scratch-resistant layer is placed on top. An electrical current runs through the two layers while the display is operational. When a user touches the screen, the two layers make contact in that exact spot. The change in the electrical field is noted and the coordinates of the point of contact are calculated by the computer. In a capacitive system, a layer that stores electrical charge is placed on the glass panel of the display. When a user touches the display with their finger, some of the charge is transferred to the user, so the charge on the capacitive layer decreases. This decrease is measured in circuits located at each corner of the display.

Two dimensional optical touch systems may be used to determine where on a screen a touch occurs. A two dimensional optical touch system may include a light source that travels across the surface of the display and is received at the opposite side of the display. If an object interrupts the light then the receiver does not receive the light and a touch is registered at the location where light from two sources that are interrupted intersect. The light source and the receiver in an optical touch system are mounted in front of the transparent layer to allow the beams to travel along the surface of the transparent layer. Some optical sensors appear as a small wall around the perimeter of the display. Mounting the light sources and receivers in front of the glass allows contaminants to interfere with the light that is transmitted between the source and the receivers.

The resistive, capacitive and the two dimensional optical touch systems can determine the XY coordinate when an object contacts or is close to the display. The resistive, capacitive and the two dimensional optical touch systems do not determine the Z dimension (third dimension), the distance from the display.

If a contact with the display is disregarded based on the two dimensional size contacting the display a computing system may disregard an object that has a small two dimensional area in contact with the display. For example a stylus with a small two dimensional surface for contacting the display may be disregarded. If a contact with the display is disregarded based on a minimum contact time of the display, quick contacts may be disregarded. For example, if a user is playing a game that requires quick contact with a portion of the screen then the system may reject contact registered for too short a period of time.

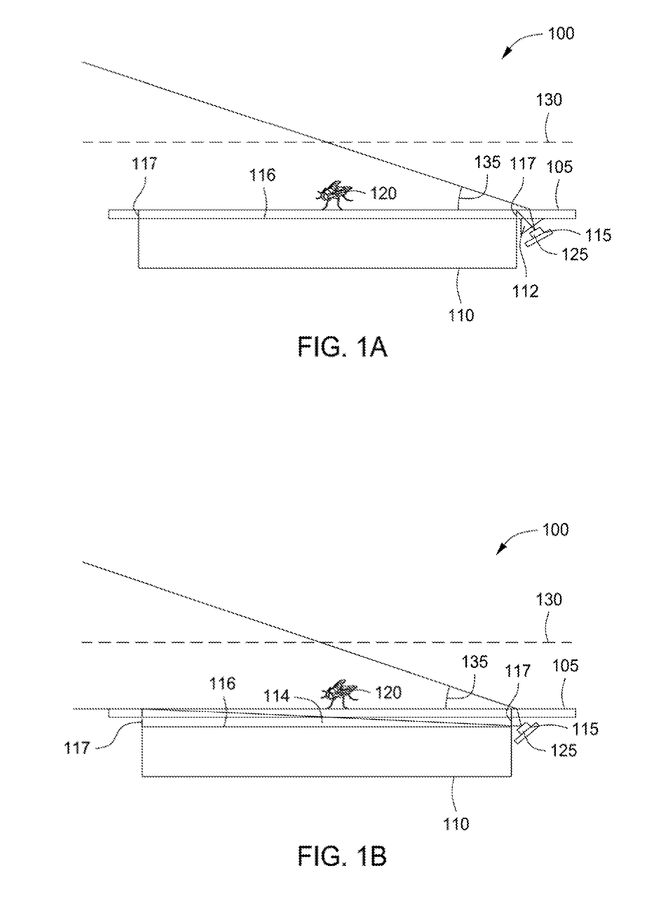

Referring to the figures, FIG. 1a is a display system 100 according to an exemplary embodiment of the invention. The display system 100 includes a panel 110 and a transparent layer 105 in front of the surface 116 of the panel 110 for displaying images. The front of the panel 110 is the surface 116 that displays an image and the back of the panel 110 is opposite the front. A three dimensional optical sensor 115 can be on the same side of the transparent layer as the panel 110. The transparent layer 105 can be glass, plastic, or another transparent material. The panel 110 may be a liquid crystal display (LCD) panel, a plasma display, a cathode ray tube (CRT), an OLED or a projection display such as digital light processing (DLP), for example. Mounting the three dimensional optical sensors in an area of the display system 100 that is outside of the perimeter 117 of the surface 116 of the panel 110 provides that the clarity of the transparent layer is not reduced by the three dimensional optical sensor.

The three dimensional optical sensor 115 can determine the depth from the three dimensional optical sensor of an object located in the field of view 135 of the three dimensional optical sensor 115. The depth of the object can be used in one embodiment to determine if the object is in contact with the display. The depth of the object can be used in one embodiment to determine if the object extends from the display to a programmed distance 130 away from the display. For example the object 120 may be an insect on a transparent layer 105 but not extending from the transparent layer 105 to the programmed distance 130.

If the object 120 is within the field of view 135 of the three dimensional optical sensor 115, light from the light source 125 can reflect from the object and be captured by the three dimensional optical sensor 115. The distance the object 120 is from the three dimensional optical sensor 115 can be used to determine the size of the object. From the size of the object 120 the distance the object 120 extends from the display system 100 can be determined. If the object does not extend from the display to a programmed distance 130 a computing system may disregard the contact. If the object extends from the display to a programmed distance 130 a computing system may generate a button activation, which may be known as a mouse click at the location of the contact between the object 120 and the display. For example, if an insect contacts the display where an image of an icon is present the computing system may disregard the contact that does not extend to the programmed distance 130 but if a finger contacts the display where an image of an icon is present the computing system may activate the function represented by the icon, such as launching a program because the finger and hand extend beyond the programmed distance.

In some embodiments, a prism 112 is used to bend the reflected light from the object to the optical sensor. The prism 112 can allow the optical sensor to see along the surface of the transparent layer 105. The prism 112 can be attached to the transparent layer 105. The prism 112 is a transparent body that is bounded in part by two nonparallel plane faces and is used to refract or disperse a beam of light. In an embodiment the prism 112 refracts a beam of light emitted from a light source 125 through the transparent layer 105 to reflect from an object and return through the transparent layer 205 to the three dimensional optical sensor 115.

FIG. 1b includes a gap 114 between the transparent layer 105 and the panel 110. The gap allows the three dimensional optical sensor 115 to have a field of view of the transparent layer 105 from between the transparent layer 105 and the panel 110. The gap may be for example from 0.1 centimeters to 0.5 centimeters but the gap may be other amounts. The field of view of the three dimensional optical sensor 115 includes the perimeter 117 on the transparent layer 105.

In one embodiment, the optical sensor can be configured after attaching the optical sensor to the panel. For example, after attaching the optical sensor to the display a computer displaying information on the panel can be trained by displaying objects on the panel. The user can then contact the display where the objects are displayed on the panel and the computer can calibrate the optical sensor so that future contact with the display is interpreted by the computer as a contact of the display.

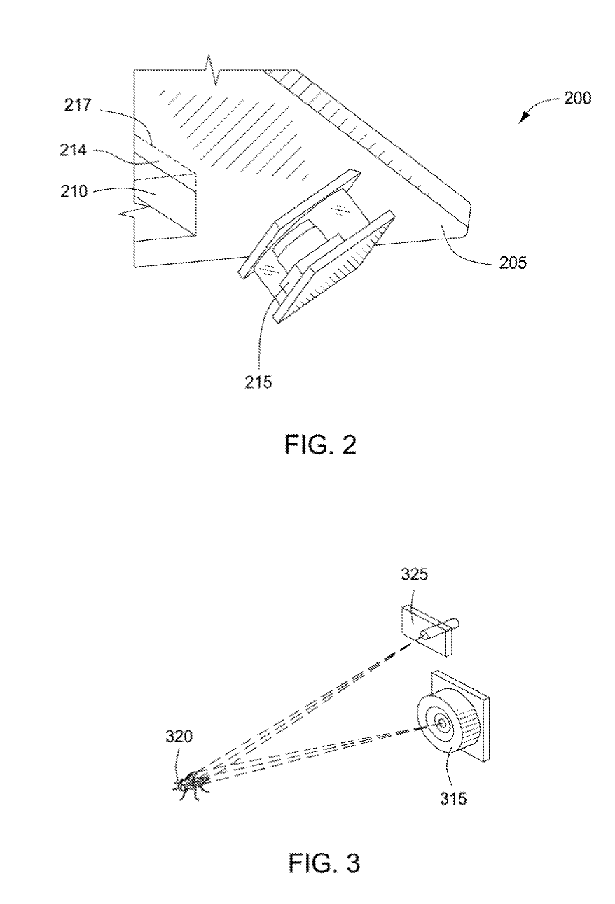

FIG. 2 is a portion of the display 200 according to an exemplary embodiment of the invention. The portion of the display 200 includes a three dimensional optical sensor 215 mounted at an angle to the transparent layer 205. The angle of the three dimensional optical sensor is determined so that the field of view of the three dimensional optical sensor 215 includes the portion of the transparent layer 205 corresponding to a perimeter 217 of the display panel 210. In one embodiment a gap 214 is between the display panel 210 and the transparent layer 205. The field of view can be determined by the lens on the three dimensional optical sensor 215. The field of view may be measured in degrees, for example the three dimensional optical sensor that has a field of view of 100 degrees can capture images that a three dimensional optical sensor with a field of view of 50 degrees would not capture.

FIG. 3 is a three dimensional optical sensor 315 according to an exemplary embodiment of the invention. The three dimensional optical sensor 315 can receive light from a source 325 reflected from an object 320. The light source 325 may be for example an infrared light or a laser light source that emits light that is invisible to the user. The light source 325 can be in any position relative to the three dimensional optical sensor 315 that allows the light to reflect off the object 320 and be captured by the three dimensional optical sensor 315. The infrared light can reflect from an object 320 that may be a contaminant and is captured by the three dimensional optical sensor 315. An object in a three dimensional image is mapped to different planes giving a Z-order, order in distance, for each object. The Z-order can enable a computer program to distinguish the foreground objects from the background and can enable a computer program to determine the distance the object is from the display.

Two dimensional sensors that use a triangulation based methods such as stereo may involve intensive image processing to approximate the depth of objects. The two dimensional image processing uses data from a sensor and processes the data to generate data that is normally not available from a two dimensional sensor. Intensive image processing may not be used for a three dimensional sensor because the data from the three dimensional sensor includes depth data. For example, the image processing for a time of flight three dimensional optical sensor may involve a simple table-lookup to map the sensor reading to the distance of an object from the display. The time of flight sensor determines the depth from the sensor of an object from the time that it takes for light to travel from a known source, reflect from an object and return to the three dimensional optical sensor. The depth of an object in the image can be determined from the three dimensional optical sensor that does not use a second three dimensional optical sensor to determine the distance of the object in the image.

In an alternative embodiment the light source can emit structured light that is the projection of a light pattern such as a plane, grid, or more complex shape at a known angle onto an object. The way that the light pattern deforms when striking surfaces allows vision systems to calculate the depth and surface information of the objects in the scene. Integral Imaging is a technique which provides a full parallax stereoscopic view. To record the information of an object, a micro lens array in conjunction with a high resolution optical sensor is used. Due to a different position of each micro lens with respect to the imaged object, multiple perspectives of the object can be imaged onto an optical sensor. The recorded image that contains elemental images from each micro lens can be electronically transferred and then reconstructed in image processing. In some embodiments the integral imaging lenses can have different focal lengths and the objects depth is determined based on if the object is in focus, a focus sensor, or out of focus, a defocus sensor. The embodiments of the invention are not limited to the type of three dimensional optical sensors that have been described but may be any type of three dimensional sensor.

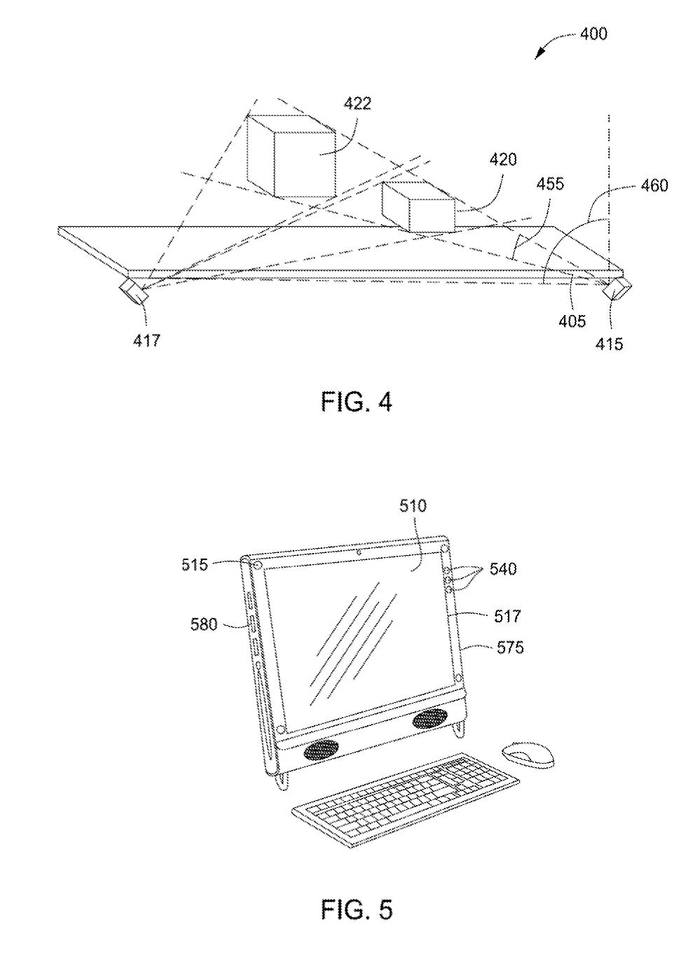

FIG. 4 is a display according to an exemplary embodiment of the invention. In sonic GUIs a display system 400 that can sense more than one object 420 may be able to perform tasks within a program that would not be recognized by a single contact. For example, moving two fingers apart may zoom in on an item and moving two fingers together may zoom out on an item.

In one embodiment, there is a first three dimensional optical sensor 415 and a second three dimensional optical sensor 417. The first three dimensional optical sensor 415 may have a field of view 460. In an embodiment that includes a gap between the transparent layer 405 and the panel a portion of the field of view may be behind the transparent layer 405. Within the field of view 460 an image of object 420 is captured. A second object 422 cannot be seen by the first three dimensional optical sensor 415 because the first object 420 is between the first three dimensional optical sensor 415 and the second object 422. The field of view 460 is obstructed by the first object 420 along the portion 455 of the field of view 460 in the volume 465 beyond the first object 420. The second three dimensional optical sensor 417 can capture within its field of view an image including the depth of both the first object 420 and the second object 422. The first three dimensional optical sensor 415 can determine the distance of a first object 420, for example an insect. The first three dimensional optical sensor 415 may not be able to capture a second object 422, for example a finger on a user's hand if the view by the first three dimensional optical sensor 415 of the second object 422 is obstructed by a the first object 420. The first three dimensional optical sensor 415 and the second three dimensional optical sensor 417 may be in the corners of the display system 400 or the optical sensors may be located anywhere in or on the display such as the top, bottom, or sides.

A three dimensional optical sensor can be used to determine the size of objects because the depth from the optical sensor is known. If the depth from the optical sensor is not known the image of an object 420 may appear the same as a larger object 422 that is further away from the optical sensor 415. The size of the object may be used by the computing system to determine the type of object, such as a hand, finger, stylus, insect, contaminant or another object.

FIG. 5 is a display according to an exemplary embodiment of the invention. The optical sensor has a viewable area that extends beyond the perimeter 517 of the display panel 510. The movement of objects beyond the perimeter 517 can activate functions of a computer system. In one embodiment, virtual buttons 540 can be located outside of the display panel 510. The virtual buttons 540 may be a symbol or text printed on the bezel 570 that surround the display panel 510. The virtual buttons have no moving parts and are not electrically connected to the computer system 580. The optical sensor 515 can detect when an object such as a user's finger has contacted a virtual button 540 but disregard contact with the virtual button from an object that does not extend from the virtual button to the programmed distance. In one embodiment, the display system may be enclosed in a housing that also encloses a computing system 580 or in an alternative embodiment the computing system may be in a separate housing from the housing of the display system.

In one embodiment, a user may control functions such as volume by moving their hand in an upward or downward motion along the side 575 of the display system 500. The side of the display can be the area outside the perimeter of the panel 510 and may include the area beyond the transparent layer. Examples of other functions that may be controlled by a user's hand along the side of the display panel are media controls such as fast forward and rewind and presentation controls such as moving to the next slide or a previous slide. If an object is moving near the side of the display such as an insect flying near the side of the display the computing system can disregard the object if the object does not extend to the programmed distance.

A user may program functions that the computer implements upon detecting certain movements. For example, a user may flip the page of the document on the display by moving their hand above the display from right to left to turn to the next page or left to right to turn to the previous page. In another example a user may move their hands in a motion that represents grabbing an object on the screen and rotating the object to rotate the object in a clockwise or counterclockwise direction. The user interface can allow the user to change the results of the hand motions that are detected by the three dimensional optical sensor. For example if the user moves their hand in front of the display in a right to left direction the computer can be programmed to interpret the motion as the flipping of a page or as closing a document. If an object is moving in front of the display such as an insect flying in front of the display the computing system can disregard the object if the object does not extend to the programmed distance. In one embodiment the depth signature of objects are stored on the computing system. The depth signature is depth information of a type of object. For example the depth signature of a hand is different than the depth signature of a contaminant such as an insect. The depth information from the three dimensional optical sensor can be compared to the depth signature information on a computing system to determine the type of object. For example, a computer may disregard objects that have depth signatures of a contaminant or a computer may disregard an object that does not have a depth signature of a non-contaminant such as a hand. A computer may disregard objects moving in front of the display system if the depth information of the object compared the depth signature of a contaminant.

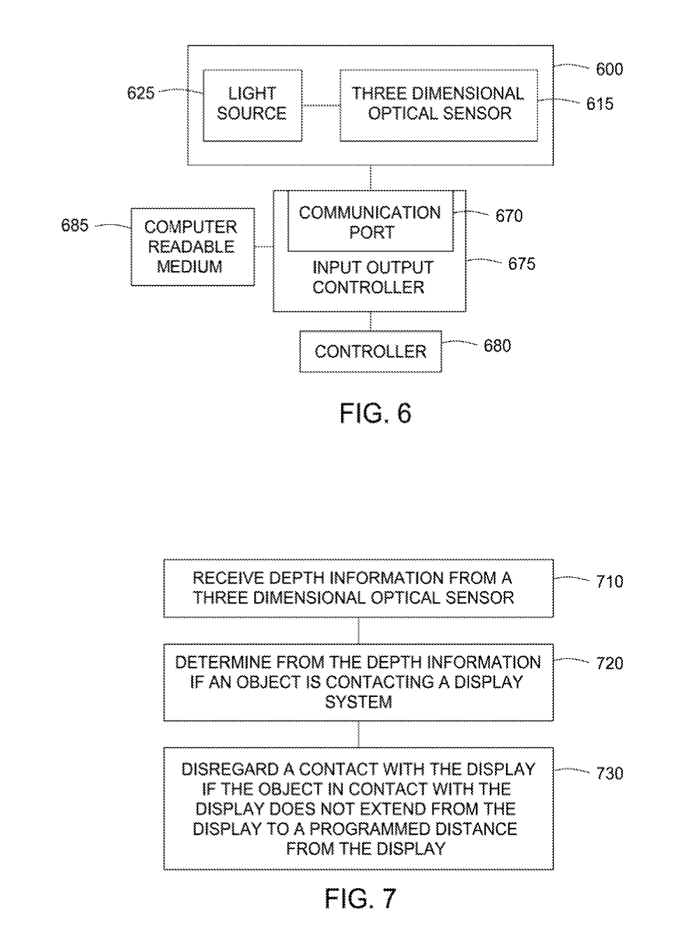

FIG. 6 is a block diagram according to an exemplary embodiment of the invention. The optical sensor module 600 includes the light source 625 and the optical sensor 615. The optical sensor module 600 can capture data that may include height, width, and depth of an object in an image. The optical sensor module 600 can connect to a communication port 670 to transmit captured data to a computing device. The communication port 670 can be a communication port 670 on a computing device. For example the communication port 670 can be a universal serial bus (USB) port or an IEEE 1394 port. The communication port 670 may be part of the input output controller 675 of the computing device, in one embodiment. The input output controller 675 can be connected to a computer readable medium 685. The input output controller 675 of a computing device can connect to a controller 680.

The controller 680 can receive data captured by the three dimensional optical sensor module 625 through the communication port 670 of the input output controller 675. The controller 680 can determine from the data captured by the three dimensional optical sensor module 600 the distance an object is from the optical sensor module 600. The controller 680 can determine the distance the object is from a display based on the distance the object is from the three dimensional optical sensor module 600. In one embodiment, the controller 680 is a processor or an application specific integrated circuit (ASIC).

A computing system including the controller 680 can use the data to determine if a contact with the display can be disregarded. For example the data may include the size of an object. If the size of the object does not extent from the display to the programmed distance the contact with the display can be disregarded.

FIG. 7 is a flow diagram according to an exemplary embodiment of the method of the invention. The method begins by receiving depth information from a three dimensional optical sensor (at 710). The depth information includes the depth of objects in the field of view of the three dimensional optical sensor. For example, the three dimensional optical sensor may use time of flight, strictured light, integral imaging or focus defocus to generate the depth information. The depth information can be received by a computing device. The computing device can be for example a computer system, a personal digital assistant or a cellular phone. The computing device can determine from the depth information if an object is contacting a display system (at 720). The computing device may determine from the depth information that the object is contacting the display if the distance of the object from the display system is substantially zero centimeters. In one embodiment, substantially zero means that the resolution of the three dimensional optical sensor may not be able to determine contact with the display and an object that is less than a contact distance from the display system may have depth information from the three dimensional optical sensor that is determined by the computing device to be a distance of zero and a contact with the display system. A contact distance may be for example 0.2 centimeters from the display system but may be other distances. If the object comes in contact with the transparent layer the calculated distance that the object is from the display is zero. If the computer receives a signal that the distance is zero the computer can generate an activation of a function represented by an icon if the computer determines that location of the object and the location of the image of the icon display on the panel correspond to each other. For example, the icon can represent a program that will be launched if the icon is activated.

The computing device can disregard a contact with the display if the object in contact with the display does not extend from the display to a programmed distance from the display (at 730). In one embodiment the contact is disregarded for the purpose of activating a computer function represented by an image of an icon at the location of the contact of the display but the display may use the contact to indicate to a user a contaminant on the display. For example an indicator, such as a circle, may be displayed at the location of the contaminant on the display.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A display system 100 comprising:
a three dimensional optical sensor 115 to generate three dimensional data for an object 120 that contacts the display system, wherein the object contacts the display system if the object is less than a contact distance from the display system; and
a controller to activate a function of a computing device only if the object extends from the display system to a distance greater than a programmed distance 130.

2. The system of claim 1 further comprising a panel 110 to display images received from the computing device on the display system 100.

3. The system of claim 1 wherein the controller disregards contact to the display system 100 if the object is contacting the display system and the object does not extend from the display system to the programmed distance 130.

4. The system of claim 1 wherein the function is an enablement of a program identified by an image displayed on the display system 100 at a location on the display system of an object that is in contact with the display system.

5. The system of claim 1 wherein the three dimensional data includes the height, width and depth of an object 120.

6. The system of claim 1 wherein the three dimensional optical sensor 115 is a time of flight optical sensor, a structured light optical sensor, a integral image optical sensor, a focus sensor or a defocus sensor.

7. A method comprising:
receiving depth information from a three dimensional optical sensor 115;
determine from the depth information if an object 120 is contacting a display system 100, wherein the object is determined to be contacting the display system if the object is less than a contact distance from the display system; and
disregarding a contact with the display system if the object in contact with the display system does not extend from the display system to a programmed distance 130 from the display system.

8. The method of claim 7 further comprising activating a function on a computing device if the object that is in contact with the display system 100 extends to the programmed distance 130.

9. The method of claim 9 wherein the function is an enablement of a program identified by an image displayed on the display system 100 at a location on the display system of an object that is in contact with the display system.

10. The method of claim 7 further comprising storing a depth signature of the object.

11. The method of claim 10 further comprising disregarding the object if the depth signature of the object is the depth signature of a contaminant.

12. The method of claim 10 further comprising disregarding the object if the object is moving in front of a front side of the display system and the depth signature of the object is indentified as a contaminant.

13. A computer readable medium comprising instructions that if executed cause a processor to:
receive three dimensional data from a three dimensional optical sensor 115;
determine from the depth information if an object 120 is contacting a display system 100, wherein the object is determined to be contacting the display system if the object is less than a contact distance from the display system; and
activate a function only if the object extends from the display system to a programmed distance 130 from the display system.

14. The computer readable medium of claim 13 further comprising instructions that if executed cause a processor to disregard the contact with the display system 100 if the object is in contact with the display system and does not extend to the programmed distance 130 from the display system.

15. The computer readable medium of claim 13 further comprising instructions that if executed cause a processor to compare the three dimensional data to a stored depth signature to determine a type of the object.
